(19) United States
(12) Patent Application Publication
(10) Pub. No.: US 2026/0212861 A1
(43) Pub. Date: Jul. 23, 2026

(54) INFORMATION HANDLING SYSTEM WITH SPEECH RECOGNITION AND FACIAL INFORMATION INPUT FOR A HANDS-FREE CONTENT EDITING

(71) Applicant: DELL PRODUCTS L.P., Round Rock, TX (US)

(72) Inventors: Yung-Sheng Lin, Taoyuan City (TW); Shun-Tang Hsu, Taipei (TW)

(21) Appl. No.: 19/032,089

(22) Filed: Jan. 19, 2025

(51) Int. Cl. G10L 15/22; G06F 3/01; G10L 15/08

(52) U.S. Cl. CPC G10L 15/22; G06F 3/012; G06F 3/013; G10L 15/08; G10L 2015/088; G10L 2015/223

(57) ABSTRACT

An information handling system may include a content editor platform that uses voice recognition and eye-tracking modules to facilitate a hands-free editing of content in a document, webpage, or browser. In an embodiment, the content editor platform may receive a voice input and a facial information input; detect an event based upon at least one of the received voice input and the facial information input; search a targeted content in response to the detected event; and edit the targeted content using the voice input.

### FIELD OF THE DISCLOSURE

The present disclosure generally relates to an information handling system and, more particularly, to a system that enables hands-free editing of content on a document, webpage, or a browser using a voice input and a facial information input.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use, such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system (or system) may use speech recognition and eye-tracking modules to facilitate a hands-free editing of content in a document, webpage, browser, or a similar area/space on a display screen that displays editable content. The content may include editable text, words, or phrases that can be targeted for user corrections or modifications via the use of a voice input and a facial information input. In an embodiment, the system may detect an event (or condition) from the received voice input or facial information input. For example, the system may detect a word or phrase (voice input) that is a preconfigured keyword. In another example, the detected word or phrase is not a preconfigured keyword; however, the system detects a repetition of the same word or phrase within a particular time period. Here, the repetition of the word or phrase may indicate an initial incorrect or failed editing of the content. In another example, the system detects a user gazing (facial information input) at an area or space on the display screen for a threshold amount of time. Upon a detection of the event in each of these examples, the system may leverage the combination of the voice input and the facial information input to search for the targeted content and to accelerate the speed of the hands-free editing of the content in the document, webpage, or browser.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an example computing environment including an information handling system that facilitates a hands-free editing of content according to at least one embodiment of the present disclosure;

FIG. 2 is a block diagram of an example content editor platform that implements the hands-free editing of the content according to at least one embodiment of the present disclosure;

FIG. 3 is a flow diagram of a method for performing the hands-free editing of the content according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

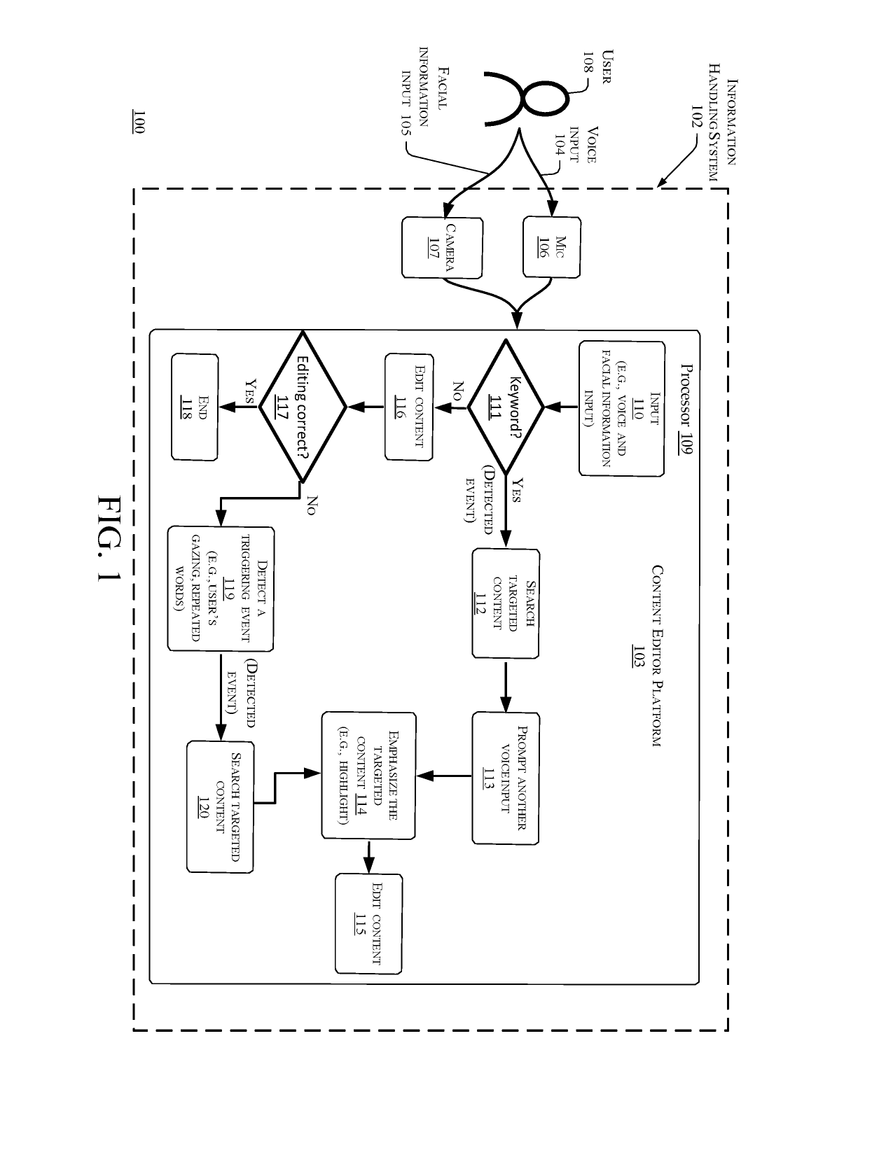

FIG. 1 illustrates an example computing environment 100 including an information handling system 102 that facilitates a hands-free editing of content, according to at least one embodiment of the present disclosure. The computing environment 100 may refer to a collection of hardware, software, and networks that interact to perform and manage computational tasks. In some embodiments, the computing environment 100 includes the information handling system 102 that utilizes a content editor platform 103 to process a voice input 104 and a facial information input 105 from a user 108. Content editor platform 103 may be executed by a processor 109. The voice input 104 and the facial information input 105 may be received through a microphone 106 and a camera 107, respectively, of the information handling system 102.

The content editor platform 103 may include speech recognition and eye-tracking modules (not shown) to process the voice input 104 and the facial information input 105, respectively. As used herein, operations described as being performed by content editor platform 103 is performed by processor 109 executing the content editor platform. The voice input 104 may be processed to detect an event based on the translated words or phrases. The facial information input 105 may be processed to detect the event based on eye movements or gaze of the user 108 towards a particular area of a display screen for a particular period. The facial information input 105 may also be used to search for targeted contents and/or highlight the targeted contents to provide a visual cue before executing the final edit. As described herein, the detection of an event includes a determined condition that triggers the use of the voice input and the facial information input to edit the targeted contents. The information handling system 102 may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes.

For example, a particular information handling system 102 may represent a computer system, such as a laptop computer, a desktop computer, a computer workstation, a server system, a blade server system, or other rack-mounted computer equipment, such as a storage server, a network server, a network switch/router, or other datacenter computer equipment, or other electronic equipment generally defined, but being characterized as including the content editor platform 103 for processing the voice input 104 and the facial information input 105 to detect the event, search for the targeted content after the detection of the event, provide a visual cue by emphasizing the targeted content, and executing the edit on the searched or emphasized targeted content using the audio-to-text translations of the voice input. The targeted content may include editable texts, words, or phrases on a document, webpage, or browser.

In an embodiment, the content editor platform 103 may include hardware and/or software that utilizes the voice input 104, facial information input 105, or a combination thereof, to accelerate the hands-free editing of the content on the document, webpage, browser, and the like. For purposes of illustration, a flow diagram of an example processing of the voice input 104 and/or the facial information input 105 is shown to demonstrate the hands-free editing and correction of the targeted contents as described herein. The content editor platform 103 may use components and/or separate applications (not shown) to implement each of the blocks in the flow diagram.

In an embodiment, the content editor platform 103 may receive and process a data stream of input 110 such as the voice input 104 and the facial information input 105. For example, the voice input (input 110) is processed and transcribed using a speech recognition module (not shown) to identify the words or phrases to be entered in the document, webpage, or browser. In some embodiments, the words or phrases may be determined to include a preconfigured keyword or repeated words and phrases that may indicate a detection of the event as described herein.

At block 111, the content editor platform 103 may determine whether the processed voice input (input 110) includes the preconfigured keyword that indicates the event. For example, the content editor platform 103 may compare the voice input in the received input 110 with stored preconfigured keywords (not shown). If the processed voice input is determined to be one of the preconfigured keywords, then at block 112, the content editor platform 103 may process the facial information input (input 110) to search for the targeted content. For example, the eye-tracking module utilizes the detected direction of the user’s gaze or eye movements towards an area of the display screen to search for the targeted content (block 112). With the identified targeted content (block 112), the content editor platform 103 may then prompt another voice input (block 113) from the user. The other voice input (block 113), which is not a preconfigured keyword, may be used to edit the targeted content at block 115. It is noted that once the event is detected at block 111, the detected user’s gaze at block 112 is used to search for the targeted content and not to trigger an event.

In some embodiments, the other voice input (block 113) and the facial information input (input 110) may be used to emphasize the targeted content (block 114). In this embodiment, the content editor platform 103 may emphasize the targeted content by further filtering the searched targeted content at block 112. For example, the searched targeted content (block 112) includes three words based on the processed facial information input. In this example, the content editor platform 103 may further filter the three words to a single word based on a contextual similarity with the prompted voice input (block 113). The single word is then highlighted to provide the visual cue to the user 108 before the execution of the edit.

Referencing block 111, the preconfigured keyword may include a phrase or word such as, “change!” “edit!” “incorrect!” or any other keyword that is preconfigured to indicate a condition for using the voice input and the facial information input to edit the targeted content. When prompted to enter another voice input, the other voice input (block 113) may include the words or phrases to correct or modify the determined targeted content (block 112).

In an embodiment, the content editor platform 103 may emphasize or highlight (block 114) the targeted content to be edited by the user 108. Here, the content editor platform 103 may use the facial information input and the voice input (block 113) to filter the targeted content to be emphasized. For example, the emphasizing of the targeted content is contextually based on the similarity with the voice input. Here, the eye-tracking module may point to a sentence having few words; however, the application of the voice input may further filter the emphasized targeted content to a single word, for example.

In an embodiment, where the received input 110 is not a preconfigured keyword (block 111), the content editor platform 103 may edit the content (block 116) based on the received voice input (input 110).

At block 117, the content editor platform 103 may determine whether the content editing (block 116) with the use of the input 110 is correct or incorrect. If the initial content editing (block 116) is correct, then at block 117, the process ends. The content editing platform 103 may determine the correct content editing based on the absence of a detected event within a preconfigured period of time. For example, if the content editing platform 103 does not detect an event within 5 seconds from the editing of the content at block 116, then this condition may indicate the correct editing of the content at block 116.

However, if the content editing platform 103 detects a triggering event (block 119), then the content editor platform 103 may use the voice input and facial information input to search for the targeted content (block 120). For example, the content editing platform 103 detects a repeated word or phrase (repeated input 110) or the user is gazing at an area for a particular period. Here, the detected repetition of the same words or phrases within a predetermined period may indicate incorrect or failed content editing (block 117) and trigger the use of the speech and facial information input to perform the content editing (block 115).

For example, the user 108 enters a verbal command “XXXX to YYYY” (input 110). When the content editor platform 103 (at block 119) detects the repeated phrase “XXXX to YYYY” within a predetermined period (e.g., within three seconds), the content editor platform 103 may then conclude the detection of the event that includes an incorrect editing of content at block 116. The content editor platform 103 may then use the facial information input (input 110) to search the targeted content at block 120. In this example, neither a portion nor all of the repeated phrase “XXXX to YYYY” include the preconfigured keyword as described herein. The content editor platform 103 may then emphasize (e.g., highlight) the targeted content at block 114 to provide the visual cue to the user 108 of the emphasized targeted content. Similar to the discussion above, the emphasizing of the targeted content may be contextually based on the similarity of the targeted content with the voice input.

At block 115, the content editor platform 103 may edit the content based on the received voice input at block 110. It is to be noted that the received voice input is not one of the preconfigured keywords as described above. Further, upon detection of the event at block 119, the detected user’s gaze at block 120 is used to search for the targeted content and not to trigger an event.

In some embodiments, the detecting of the triggering event (block 119) may be based on the detected movements of the user’s gaze or vision (input 110). The detecting of the user’s gaze may indicate incorrect editing of the content (block 116) even though no voice input is detected, i.e., voice input has no sound. Here, the content editor platform 103 may detect the event based on the user’s gaze. For example, the content editor platform 103 may use a time threshold on the user’s gaze on a particular area of the screen. The content editor platform 103 may then detect the event (block 119) based on the length of time of the user’s gaze on the particular area of the screen.

For example, the user 108 enters the verbal command “XXXX to YYYY” (input 110). When the content editor platform 103 detects the user’s gaze on the same area of the screen for a particular period, the content editor platform 103 may indicate this act to be an event (block 119) that triggers the use of the voice input and the facial information input (input 110) to search the targeted content at block 120. In another example, the user 108 does not enter any verbal command, but the user’s gaze on the same area triggers the detection of the event. In this case, the content editor platform 103 may prompt (not shown) the user 108 to enter a voice input that can be used to edit the targeted content.

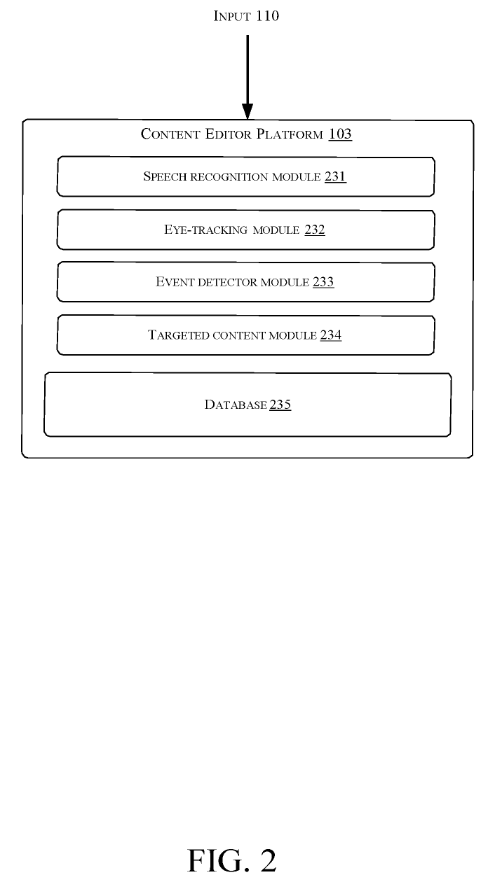

FIG. 2 is an example block diagram of the content editor platform 103 that implements the hands-free editing of the content according to at least one embodiment of the present disclosure. The content editor platform 103 may use a speech recognition module 231, eye-tracking module 232, event detector module 233, a targeted content module 234, and a database 235 to accelerate the hands-free editing of the content on the document, webpage, or browser.

The speech recognition module 231 may include software or hardware component configured to interpret and transcribe voice commands into actionable input (machine-readable text). In an embodiment, the transcribed voice commands may be determined to be similar to the preconfigured keywords stored in the database 235. Here, output (not shown) of the speech recognition module 232 may include words or phrases that can be compared by the event detector module 233 to the stored preconfigured keywords (database 235) to determine the presence of the event as described herein. Upon detection of the event, the event detector module 233 may utilize the detected user’s gaze to search for the targeted content and not to trigger a detection of another event.

In some embodiments, where the user is prompted to enter another voice input as described in FIG. 1, the speech recognition module 231 may generate the transcribed voice commands that can be used to edit the targeted content.

The eye-tracking module 232 may include software and hardware components to monitor and interpret the position and movement of a user's gaze. Upon detection of the event as described herein, the eye-tracking module 232 may be utilized to detect the user’s gaze for searching of the targeted content. For hands-free content editing in a browser, webpage, or document, the eye-tracking module 232 may be configured to identify where the user is looking to enable precise text selection, which can be used by the targeted content module 234 to identify the targeted content for correction or modification.

In some embodiments, the detected user’s gaze may be interpreted as a detected event. For example, the eye-tracking module 232 may detect the user’s gaze on a particular area of the display screen for five seconds. Here, the event detector module 233 may utilize this information to detect the event. For example, the event detector module 233 may use a predetermined time period of five seconds for the user’s gazing on the same area to indicate the event. In this example, the event may be detected even though no voice input was initially received from the user. Upon the detection of the event, the user is prompted to enter the voice input that can be used to edit the targeted content. The prompted voice input may not include preconfigured keywords unless the desired modification is using words or phrases that are similar to the preconfigured keywords. In this case, the user can be prompted to enter manually the corrections.

The event detector module 233 may include software and hardware components to detect the condition (event) that enables the use of the voice input and the facial information input to edit the targeted content. As described above, the event detector module 233 may detect the event based on the voice input. For example, the voice input includes the preconfigured keyword. The event detector module 233 may further detect the event based on the facial information input. For example, the user’s gaze on a particular area of the display screen for five seconds may indicate the detection of the event as described herein. In some embodiments, the event detector module 233 flags the detection of the event so that the detected subsequent movements of the user’s gaze can be used to search for the targeted content.

The targeted content module 234 may include software and hardware components to identify and select text, words, and/or phrases based upon the detected eye movement of the user, voice input, or a combination thereof.

Database 235 may store the voice input, eye-tracking movements, historical data of detected events, and other information to support the operation of the content editor platform 103.

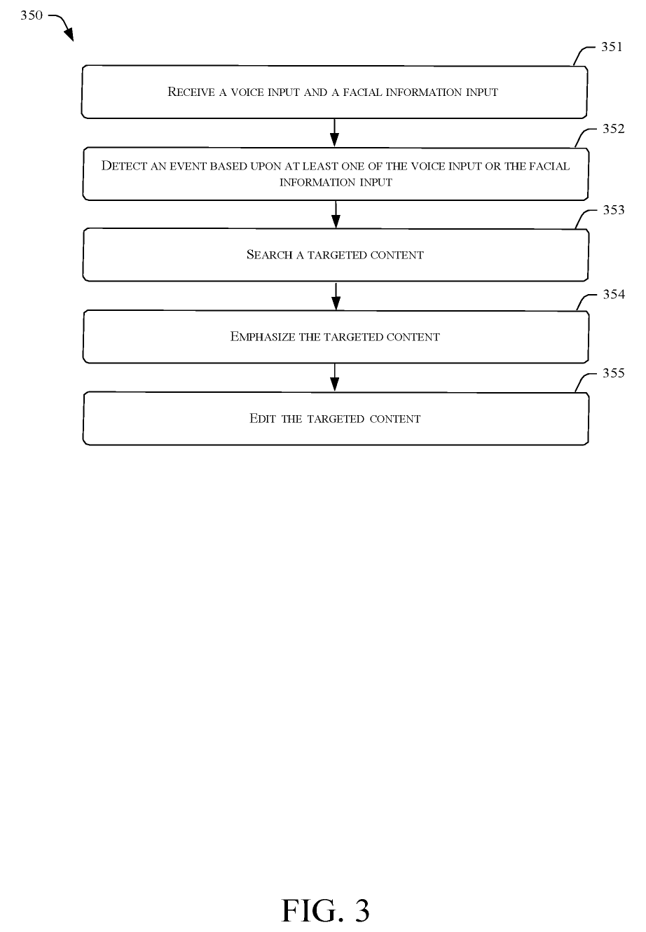

FIG. 3 is a flow diagram of a method 350 for hands-free content editing according to at least one embodiment of the present disclosure, starting at step 351. It will be readily appreciated that not every method step set forth in this flow diagram is always necessary, and that certain steps of the methods may be combined, performed simultaneously, in a different order, or perhaps omitted, without varying from the scope of the disclosure. FIGS. 1-2 may be employed in whole, or in part, by a controller (content editor platform 103) of the information handling system 102 of FIG. 1, or any other type of controller, device, module, processor, or any combination thereof, operable to employ all, or portions of, the method of FIG. 3.

At step 351, the content editor platform 103 may receive an input that includes voice input and a facial information input. For example, the content editor platform 103 may receive voice input 104 and facial information input 105 from the user 108.

At step 352, the content editor platform 103 may detect an event based upon at least one of the received voice input and the facial information input. For example, the detected event may include the detection of the preconfigured keyword from the received input. In another example, the detected event may include the detection of the user’s gaze on a particular area of the display screen for a determined period. In another example, the detected event may include the detection of a repetition of words or phrases within a time period.

At step 353, in response to the detected event, the content editor platform 103 may search for a targeted content. In some embodiments, where the user’s gaze is used for the detected event, the event detector module may flag the timestamp between the use of the user’s gaze for the detection of the event and for the searching of the targeted content. For example, once the event is detected, the user’s gaze as described herein is used to search or highlight the targeted content and not used to determine another event.

At step 354, the content editor platform 103 may edit the targeted content using the voice input. In some embodiments, where the initial voice input is used in the determination of the event, the user may be prompted to enter another voice input other than the preconfigured keywords. The other voice input may be used to edit the targeted content.

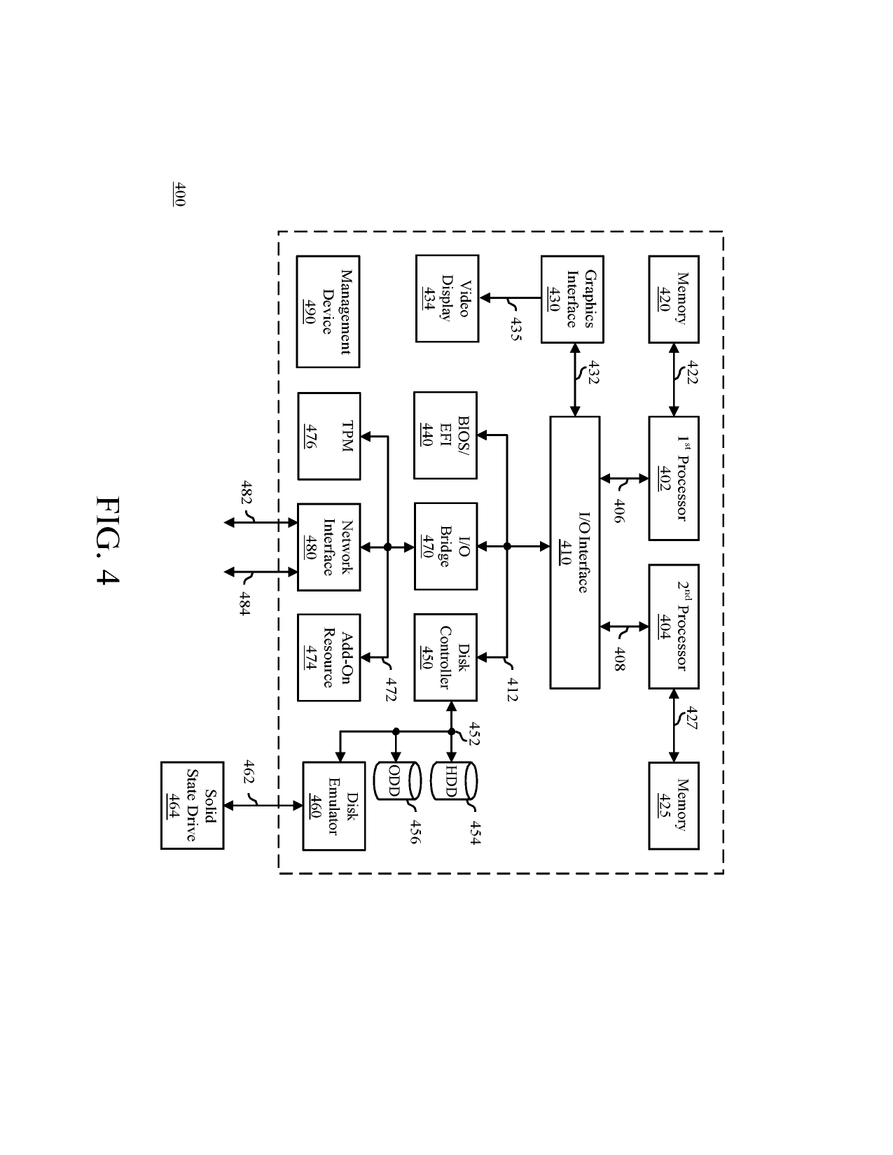

FIG. 4 shows a generalized embodiment of an information handling system 400 according to an embodiment of the present disclosure. Information handling system 400 may be substantially similar to information handling system 102 of FIG. 1 that implements or includes the content editor platform 103. For the purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operate to perform one or more of the methods described below. Information handling system 400 includes processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456 , a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. In some embodiments, the processor 402 or 404 may implement the functionalities of the content editor platform 103 as described herein. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces to support the hands-free content editing of the targeted contents. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (event detector module), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory;
a processor coupled to the memory, the processor configured to:
provide content on a display device of the information handling system;
receive a voice input and a facial information input;
detect an event based upon at least one of the received voice input and the facial information input;
in response to the detected event, search the content for a targeted content; and
edit the targeted content using the voice input.

2. The information handling system of claim 1, wherein the voice input includes a preconfigured keyword.

3. The information handling system of claim 2, wherein the preconfigured keyword includes a word or a phrase that triggers a use of the facial information input to search for the targeted content.

4. The information handling system of claim 2, wherein the processor is further configured to:
prompt a user to enter another voice input other than the preconfigured keyword,
wherein the processor edits the targeted content utilizing the other voice input.

5. The information handling system of claim 1, wherein the voice input includes a repeated word or phrase.

6. The information handling system of claim 5, wherein the repeated word or phrase triggers a use of the facial information input to search for the targeted content.

7. The information handling system of claim 5, wherein the repeated word or phrase is not a preconfigured keyword.

8. The information handling system of claim 5, wherein the processor is further configured to: edit the targeted content using the repeated word or phrase.

9. The information handling system of claim 1, wherein the received facial information input includes a user’s gaze, wherein the processor is further configured to:
compare a time period of the user’s gaze on a particular area of a display screen for a predetermined period,
detect the event based at least upon the comparison between the time period of the user’s gaze on the particular area of the display screen and the predetermined period.

10. The information handling system of claim 1, wherein the processor is further configured to:
emphasize the targeted content.

11. A method comprising:
providing, on a display device of a information handling system, content;
receiving, by a processor of the information handling system, a voice input and a facial information input;
detecting, by the processor, an event based upon at least one of the received voice input and the facial information input;
in response to the detected event, searching the content for a targeted content; and
editing the targeted content using the voice input.

12. The method of claim 11, wherein the voice input includes a preconfigured keyword.

13. The method of claim 12, wherein the preconfigured keyword includes a word or a phrase that triggers a use of the facial information input to search for the targeted content.

14. The method of claim 12, wherein the method further comprises:
prompting a user to enter another voice input other than the preconfigured keyword,
wherein the editing of the targeted content utilizes the other voice input.

15. The method of claim 11, wherein the voice input includes a repeated word or phrase.

16. The method of claim 15, wherein the repeated word or phrase triggers a use of the facial information input to search for the targeted content.

17. The method of claim 15, wherein the editing of the target content utilizes the repeated word or phrase.

18. An information handling system comprising:
a microphone to receive a voice input;
a camera to receive a facial information input; and
a processor configured to:
provide content on a display device of the information handling system;
process the voice input and the facial information input;
detect an event based upon at least one of the voice input and the facial information input;
in response to the detected event, search the content for a targeted content; and
edit the targeted content using the voice input.

19. The information handling system of claim 18, wherein the voice input includes a preconfigured keyword.

20. The information handling system of claim 19, wherein the processor is further configured to:
prompt a user to enter another voice input other than the preconfigured keyword,
wherein the processor edits the targeted content utilizing the other voice input.
